(19) United States
(12) Patent Application Publication
(10) Pub. No.: US 2007/0227508 A1
(43) Pub. Date: Oct. 4, 2007

(54) Method of retarding injection timing of mechanical unit injectors using a modified pump barrel

(75) Inventors: Schultz Gregory Lee, Naples, FL (US); Ed A. Schlairet, Naples, FL (US); Edward H. Harrison, Goodland, FL (US)

Correspondence Address: EDWARD M. LIVINGSTON, PA, 963 TRAIL TERRACE DRIVE, NAPLES, FL, 34103, US

(73) Assignee: Haynes Corporation

(21) Appl. No.: 11/397,201

(22) Filed: Apr. 4, 2006

(51) Int. Cl. F02M 47/02; F04B 7/04

(52) U.S. Cl. 123/500; 239/88; 417/499

(57) ABSTRACT

A modified barrel device (1) and method of retarding injection timing of EMD-type unit injectors by a desired amount of crank degrees includes the steps of providing a modified pump barrel (8) whose port locations differ, in their spacing from the top shoulder of the associated barrel, that corresponds to the spacing from the top face of the associated follower, from the spacing of the barrel port sealing location of the pump barrel of the original injector from the top shoulder of the associated barrel, that corresponds to the top face of the associated follower (2), such difference in spacing being by an amount equal to the amount of retardation, in linear units, that corresponds to the desired amount of retardation in crank degrees, and assembling the modified pump barrel (8) into an injector assembly.

### BACKGROUND OF THE INVENTION

This invention relates to fuel injectors, more particularly, a modified pump barrel for use in retarding injection timing of EMD-type unit injectors in diesel engines.

EMD-type unit injectors are injectors that feature mechanical unit injectors (as opposed to electronic control) and are widely used in the diesel engine industry, including the locomotive industry. However, with the increase of concern of harmful emissions from diesel engines and overall energy conservation, modifications to EMD-type unit injectors have become necessary so as to be more environmental friendly.

Although the prevalence of photochemical smog in metropolitan areas spurred the first public interest in reducing noxious emissions from exhaust emissions, reducing output of all types of harmful emissions, including carbon monoxide (CO), hydrocarbons (HC) and nitrous oxides (NOx) has become one of the goals of the diesel engine industry. Through the years, the diesel engine industry has greatly reduced the smoke, carbon monoxide and hyrdrocarbons emitted into the atmosphere. However, it is the nitrous oxides and particulate emissions that remain one of the plaguing problems for diesel engines.

In order to reduce the amount of nitrogen oxides emitted, the injector should create less heat in the combustion chamber. One method to create less heat, and thereby produce less nitrogen oxides, is by retarding the injection timing of the fuel injectors. By retarding the timing of diesel fuel injections, the combustion process occurs at a later time in the power stroke. By retarding the timing, the combustion temperature and pressure are lowered, thereby causing less nitrogen oxides to form. The amount of nitrogen oxide lessens with higher levels of retard.

The drive linkage (which includes the associated engine cam, a rocker arm assembly, a socket pad on the head of the adjusting screw and a spring-loaded tappet or follower carried by the injector pad and slidably engaged by the pad) powers the injector pump to actuate the injector plunger as determined by the engine cam profile. One possible method for retarding timing is by adjusting the screw on the output end of the engine rocker arm. As the adjusting screw is turned, the free length of the adjusting screw below the output end of the rocker arm is changed and creates a new set screw set point. As a result, the drive linkage is either shortened or lengthened until there is a predetermine specified timing distance between the top face of the follower and a fixed surface, namely the top flat face of the injector body. The specified timing distance is the distance that is obtained when the port closure of the helix of the plunger is above the point at which it will close off its associated spill port in the plunger bushing to thereby initiate injection, which is known as its set point. The set point is usually listed on the engine manufacturer's data plate. If the set point listed on the data plate does not match with the set point for the now retarded injector, a new setting gauge and new engine marking must be provided.

In addition, the new timing distance specification or adjusting screw set point prescribed to retard injection timing may vary from engine model to engine model. This variation creates a potential for human error wherein a mechanic must use multiple gages to set multiple engines.

Thus, a need exists for a method of retarding injection timing of mechanical unit injectors that is simple and minimizes human error in reducing undesirable emissions.

The relevant prior art includes the following references:

| U.S. Pat. No. | | |
|---|---|---|
| (U.S. unless stated otherwise) | Inventor | Issue/Publication Date |
| 6,321,723 | Merkle et al. | Nov. 27, 2001 |
| 6,763,810 | Jones | Jul. 20, 2004 |
| 3,982,693 | Hulsing | Sep. 28, 1976 |
| 4,984,738 | Winquist | Jan. 15, 1991 |
| 4,317,541 | Beardmore | Mar. 2, 1982 |
| 4,054,248 | Beardmore | Oct. 18, 1977 |
| 2,898,051 | Teichert | Aug. 4, 1959 |
| 4,213,564 | Hulsing | Jul. 22, 1980 |
| 5,328,094 | Goetzke et al. | Jul. 12, 1994 |
| 6,439,204 | Duquette | Aug. 27, 2002 |

### SUMMARY OF THE INVENTION

The primary object of the present invention is to provide a method of retarding injection timing of mechanical unit injectors which reduces the amount of nitrogen oxides emitted from a diesel engine.

Another object of the present invention is to provide a method of retarding injection timing of mechanical unit injectors that does not require specifying a new timing distance.

An even further object of the present invention is to provide a method of retarding injection timing of mechanical unit injectors that does not require the providing of a new setting gauge and/or new engine marking.

Another object of the present invention is to provide a method of retarding injection timing of mechanical unit injectors that could be used on all diesel engines.

The present invention fulfills the above and other objects by providing a method of retarding injection timing of mechanical unit injectors wherein a modified pump barrel is used. The modified pump barrel includes at least one port whose location differs in comparison to conventional barrels. The differences in spacing of the at least one port is an amount equal to the amount of retardation, in linear units, that corresponds to the desired amount of retardation in crank degrees.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a cut-away side view of a fuel injector of the present invention;

FIG. 2 is a series of diagrams showing varying stroke movements of the present invention;

FIG. 3 is a downward looking plan view of the fuel injector of the present invention;

FIG. 4 is a partial cut-away cross-sectional plan view of the modified pump barrel of the present invention;

FIG. 5 is a partial cut-away cross-sectional plan view of a conventional method for retarding injection timing; and

FIG. 6 is a partial cut-away cross-sectional plan view of a method of retarding injection timing of the present invention.

### DESCRIPTION OF THE PREFERRED EMBODIMENTS

For purposes of describing the preferred embodiment, the terminology used in reference to the numbered components in the drawings is as follows:

1. fuel injector, generally

2. pump follower

3. pump plunger

4. plunger head

5. top port

6. bottom port

7. t-slot

8. pump barrel

9. locating pin

10. valve nut

11. body

12. cylinder

13. adjusting screw

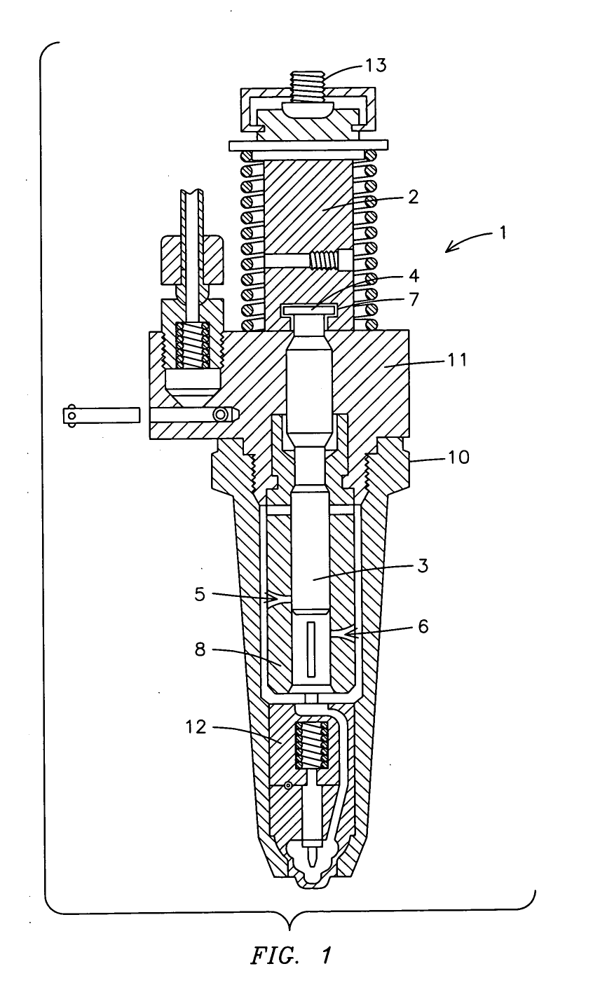

With reference to FIG. 1, a cut-away side view of a fuel injector of the present invention is shown. The fuel injector 1 includes a body 11 of a conventional unit injector. A valve nut 10 holds the pump barrel 8 of the present invention to the body 11. A pump plunger 3 having a plunger head 4 is slidably received within the pump barrel 8. A pump follower 2 having a t-slot 7 receives a plunger head 4 of the pump plunger 3. Thus, the pump plunger 3 and pump follower 2 are in end-to-end arrangement and move as one unit when in use. The pump barrel 8 includes a top port 5 and a bottom port 6 for the admittance and remittance of fuel. An adjusting screw 13 is located on a flat top surface of the pump follower 2.

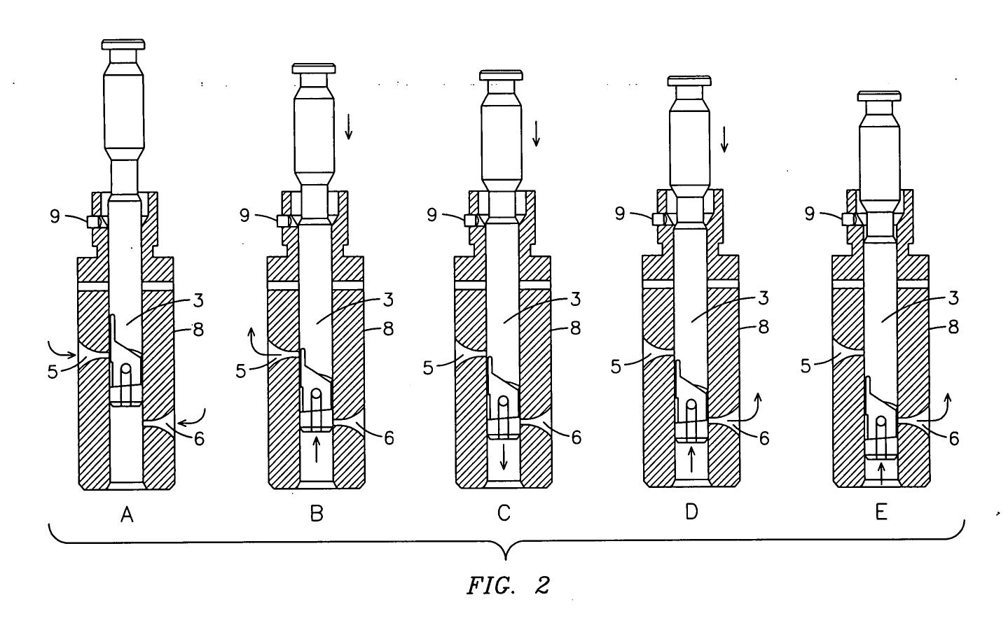

In FIG. 2, a series of diagrams showing varying stroke movements of the present invention is shown. Assuming that an injector's adjusting screw is adjusted to its set point, that is, the point where the timing distance is equal to the timing distance indicated on the engine data plate, the originally desired injection timing is obtained. When the pump plunger 3 is fully retracted, both the upper and lower ports 5 and 6 are open to admit fuel (2A), which is the first step in the stroke. Then, during the start of the stroke, fuel escapes through the upper port 5 (2B) and, when injection begins, both ports 5 and 6 are closed, thereby forcing fuel into the cylinder (2C). Injection duration continues until at least one port 5 or 6 is open, thereby allowing fuel to escape (2D). Finally, at the bottom of the stroke, the lower port 6 is fully open (2E).

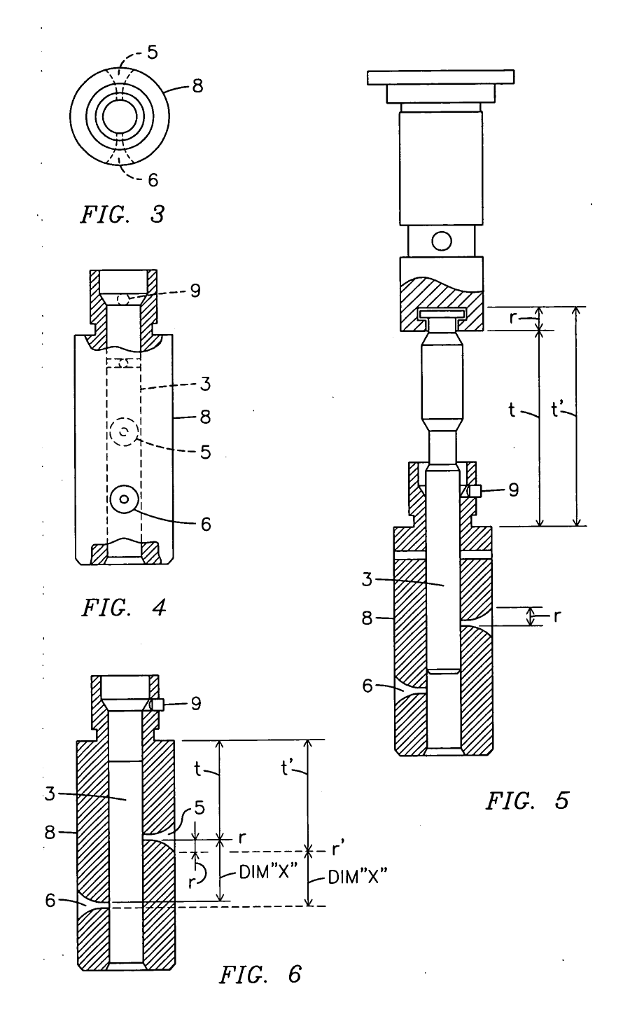

FIG. 3 shows a downward looking plan view of the fuel injector of the present invention. The barrel 8 includes a top port 5 and a bottom port 6 wherein the top port 5 has a smaller radius than the bottom port 6. The ports 5 and 6 extend from the barrel 8 to the pump plunger 3 so as to provide fuel to access the cylinder 12. In addition, both ports 5 and 6 are conically-shaped so as the radius of the ports 5 and 6 are larger in diameter on the surface of the barrel 8 and are smaller in diameter as the ports 5 and 6 extend towards the pump plunger 3.

Next, FIG. 4 shows a partial cut-away cross-sectional plan view of the modified pump barrel of the present invention. The ports 5 and 6 are on opposing sides of the barrel 8 wherein the upper port 5 is located at a predetermined location on the barrel 8 above (closer to the pin 9) the lower port 6.

As shown in FIG. 5, the originally desired injection timing, the timing specified on the engine data plate, is t. When using one method of retarding injection timing, an adjusting screw is manipulated so as to decrease its free length to a point where a new specified timing distance t′, also known as a new set point, is established. The difference between the new specified timing distance t′ and the originally desired injection timing t is the amount of retardation, r. The amount of retardation r, which is expressed in linear units, corresponds to the desired amount of retardation in crank degrees. However, because the new set point t′ on the now retarded injection does not correspond to the originally desired injection timing set point listed on the engine data plate t, a new timing distance t′ (set point) must be specified so that future adjustments may be made to the new timing distance t′ (set point).

Finally, FIG. 6 shows a partial cut-away cross-sectional plan view of a method of retarding injection timing of the present invention. The present invention eliminates the use for specifying a new timing distance t′ by retarding injection timing by providing a modified pump barrel 8 whose predetermined port 5 and 6 locations differ from conventional pump barrels. The ports 5 and 6 of the modified pump barrel 8 are increased in the distance from the top shoulder of the associated barrel that corresponds to the spacing from the top face of the associated follower from the spacing of the barrel port sealing location of the pump barrel of the original injector from the top shoulder of the associated barrel that corresponds to the top face of the associated follower. The difference in spacing is an amount equal to the amount of retardation in linear units that corresponds to the desired amount of retardation in crank degrees. Although the original timing distance t is reduced when retarding the injection timing using the present invention to t′, because the spacing differential r applies to all points on the modified pump barrel 8, there is no need to specify a new timing distance or provide a new setting gauge and/or new engine marking.

The use of the present invention will permit a person to easily retard the injection timing of EMD-type unit injectors without specifying a new timing distance or providing a new setting gauge and/or new engine marking.

In addition, although the use of the present invention is described with respect to EMD-type unit injectors in diesel engines, the present invention could also be used in conjunction with all types of diesel engines, such as semi-trucks, marine vehicles, off-highway and on-highway vehicles, etc.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A method of providing an injector to be used in a given model of an engine and having its injection timing retarded by a given amount r, expressed in lineal units, as compared to a reference injector with unretarded timing and previously used in said given model, said given amount r, expressed in lineal units, corresponding to a desired amount of retardation expressed in crank degrees, said method comprising the steps of:
a. determining the distance from follower top spacing of a first representative point on the operative portions of the plunger helices of said reference injector from the top face ofthe follower of the reference plunger when the plunger and follower are assembled together;
b. providing a modified barrel having predetermined port locations from the top shoulder of the associated barrel that corresponds to the spacing from the top face of the associated follower, from the spacing of the barrel port sealing location of the pump barrel of the original injector from the top shoulder of the associated barrel that corresponds to the top face of the associated follower wherein said predetermined port locations correspond to the desired amount of retardation in crank degrees; and
c. assembling said modified pump barrel into an injector assembly.

2. A modified barrel and injector to be used in a given model of an engine and having its injection timing retarded by a given amount r, expressed in lineal units, as compared to a reference injector with unretarded timing and previously used in said given model, said given amount r, expressed in lineal units, corresponding to a desired amount of retardation expressed in crank degrees having predetermined port locations from the top shoulder of the associated barrel that corresponds to the spacing from the top face of the associated follower, from the spacing of the barrel port sealing location of the pump barrel of the original injector from the top shoulder of the associated barrel that corresponds to the top face of the associated follower wherein said predetermined port locations correspond to the desired amount of retardation in crank degrees.
